(19) United States
(12) Patent Application Publication
(10) Pub. No.: US 2005/0133720 A1
(43) Pub. Date: Jun. 23, 2005

(54) Corona shield, and method of making a corona shield

(75) Inventors: Christian Russel, Jena (DE); Volker Muhrer, Furth (DE); Alexander Maurer, Nurnberg (DE); Bernhard Klaussner, Nurnberg (DE); Klaus Schafer, Nurnberg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/014,632

(22) Filed: Dec. 16, 2004

Related U.S. Application Data
(63) Continuation of application No. PCT/DE03/01865, filed on Jun. 5, 2003.

(30) Foreign Application Priority Data
Jun. 18, 2002 (DE) 102 27 226.3

(51) Int. Cl. G03G 15/02

(52) U.S. Cl. 250/324

(57) ABSTRACT

A corona shield for an electrical machine includes a non-woven fabric of fibers or a fabric of threads, wherein the fibers or threads contain electrically conductive inorganic material.

### CROSS-REFERENCES TO RELATED APPLICATIONS

This application is a continuation of prior filed copending PCT International application no. PCT/DE03/01865, filed Jun. 5, 2003, which designated the United States and on which priority is claimed under 35 U.S.C. §120, and which claims the priority of German Patent Application, Serial No. 102 27 226.3, filed Jun. 18, 2002, pursuant to 35 U.S.C. 119(a)-(d).

### BACKGROUND OF THE INVENTION

The present invention relates, in general, to a corona shield for an electric machine, and to a method of making a corona shield.

Nothing in the following discussion of the state of the art is to be construed as an admission of prior art.

A typical corona shield includes at least a fabric or a non-woven fabric made of glass or polyester. Examples of fabrics are referred to in DIN-standards (German Industrial Standard) DIN 16740 and DIN 16741 from the year 1976 (January). DIN 16740 relates to a textile glass fabric for electronic applications, whereas DIN 16741 relates to textile glass fabric bands with firm selvedges for electronic applications. The fabrics are used, for example, as substrate for impregnating fluid to provide electric properties. While impregnation enables the production of a corona shield, there are many drawbacks associated therewith. The corona shield produced through impregnation is only partially hardened. During the impregnation of the electric machine, also called VPI process (Vacuum Pressure Impregnation), the electric conductivity of the partially hardened corona shield is adversely affected and may change.

A corona shield may also be made, for example, by a chemical reduction process, as disclosed in U.S. Pat. No. 3,639,113. The need for a reduction process is not only disadvantageous but also limits the establishment of electrical conductivity to only a top layer of the corona shield. Thus, electric conductivity cannot be realized across the entire cross section. Moreover, the top layers of the corona shield can get damaged, when the electric conductors, on which the corona shield is attached, are installed, normally by hammering, into the slots of an electric machine. Since only the top layers of the corona shield are electrically conductive, the electric conductivity of the corona shield will thus be reduced in an undesired way.

Typically, corona shield is produced by using as base material a glass fabric which is non-conducting and soaked in a solvent. Corona shielding is normally differentiated between OCS, short for outer corona shield, and ECS, short for end corona shield. When ECS is involved, silicon carbide (SiC) in combination with an organic binder like resin and the glass fabric is used to produce the corona shield. OCS is made by using the glass fabric together with soot and/or graphite and an organic binder such as resin. A drawback of organic binders is their poor resistance to thermal stress which can result in a change of positioning of the electrically conductive materials within the binder so that ultimately the electric conductivity is altered. Contact between the electrically conducting materials (SiC, soot, graphite) gets lost or at least decreases, causing a reduced conductivity. The provision of soot is also disadvantageous because it is prone to wear off, as the corona shield is handled, so as to produce rubbings which also adversely affect the electric conductivity.

When single rod impregnation is involved, filler-containing coats are used. The slot area includes electrically conductive fillers, typically soot or graphite, whereas semi-conducting silicon carbide is used in the area of the winding end portions. As a consequence of the required use of organic binder and its limited resistance to thermal stress (up to about 180°), the used materials will be destroyed by partial discharges or glow discharges. In addition, the electric conductivity is adversely affected by the VPI impregnation process. Through rubbing or flushing, the VPI impregnation fluid as well as adjacent insulation areas may be contaminated by the electrically conductive fillers.

The use of organic material is also disadvantageous because of the adverse impact of ozone that is produced during partial discharges. Ozone destroys organic material, e.g. resin, and as a result of the destruction of the organic material, partial discharges in the electric machine increase further on the conductors, thereby forming even more ozone that leads to the increasing destruction of the organic material, ultimately causing a breakdown of the electric machine. Soot or graphite is for example used as filler for the organic material for providing the electric conductivity. A glass fabric or a polyester fabric is impregnated with the filler-containing organic resin which may also contain silicon carbide for increasing the electric conductivity. The use of organic resin limits, however, the maximum temperature at which the electric machine can operate properly. The ozone generated by partial discharges also destroys the soot or graphite contained in the organic resin. Soot forms together with ozone CO or CO₂ so that the electric conductivity of the corona shield decreases and the organic resin increasingly dissolves, ultimately destroying the corona shield.

It would therefore be desirable and advantageous to provide an improved corona shield for an electric machine to obviate prior art shortcomings and to exhibit reproducible electric properties while having extended service life.

### SUMMARY OF THE INVENTION

According to one aspect of the present invention, a corona shield for an electric machine includes a substrate which is made of filaments which contain electrically conductive inorganic material. The substrate may be realized in the form of a fabric made of threads which contain the electrically conductive inorganic material and/or in the form of a non-woven fabric made of fibers which contain the electrically conductive inorganic material.

In this application, the term “filament” as referred to throughout this disclosure is used here in a generic sense and covers any thin continuous object such as, e.g., thread, strand, string or fiber.

The present invention resolves prior art shortcomings by allowing the production of a corona shield which can be made solely of inorganic material without any addition of organic material.

The filaments may be made partly or entirely of electrically conductive inorganic material, whereby the material or combination of materials may be best suited to the desired electric conductivity.

According to another feature of the present invention, the filaments may be made of glass. The conductivity of the filaments may be realized by including a transition metal oxide as electrically conductive inorganic material. Examples of metals include iron, vanadium, manganese, chromium, cobalt, nickel, copper, arsenic, or antimony. The concentration of the electrically conductive inorganic material depends on the desired electric conductivity. Currently preferred is a range of concentration for adjusting the electric conductivity of about 5% to 35%, although there may be circumstances when the desired electric conductivity may require a different range of concentration of the electrically conductive inorganic material. In the event of iron as electrically conductive inorganic material, FeO and Fe₂O₃ may be used as oxides of iron.

The electric properties of the corona shielding are significantly determined by the electric properties of the material used for the substrate. Suitably, the material for the filaments includes inorganic material at a particular concentration of the electrically conductive inorganic material. Compared to electrically conductive organic material that has been used for making corona shielding, the use of electrically conductive inorganic material is much less sensitive to partial discharges. When exposed to partial discharge, the formation of ozone has no significant impact on inorganic materials involved here or on their combination with ozone.

The electric conductivity of a corona shield according to the present invention is not adversely affected by any rubbed-off parts, when wrapped around insulated conductors of an electric machine so that a corona shield according to the present invention is better and easier to handle. As a consequence, production of an electric machine and wrapping of conductor bars with a corona shield according to the invention is easier because of the lesser sensitivity of the corona shield. Also, there is no adverse affect on a corona shield according to the present invention during impregnation of the electric machine by the VPI process.

A corona shield according to the present invention finds application in particular for protecting the insulation of electric machines, such as motors, e.g. rail traction motors, and generators, in particular turbo generators at voltages in kV range, especially greater or equal 3.3 kV. When voltage of greater than 3.3 kV is applied, care should be taken to prevent partial discharge or glow discharge and to provide corona shielding. In this context, the terms “inner corona shield” or “outer corona shield” refer to the slot area of a laminated core of an electric machine, while the term “end corona shield” relates to the area of the winding end portion.

A corona shield according to the present invention may be realized in the form of a fabric band or non-woven band. The band can be made from electrically conductive endless fibers or staple fibers. The required electric conductivities for inner corona shielding and outer corona shielding (5*10² Ω/squared to 5*10⁴ Ω/squared) and for the end corona shielding (5*10⁷ Ω/squared to 5*10⁹ Ω/squared) can be realized by different doping, i.e. through different concentrations of the electrically conductive materials/substances/chemical compounds within the filaments. Filaments which have been designed in this way are intrinsically conductive.

Glass with intrinsic electron conductivity can be used for application as corona shield for end corona shielding as well as outer corona shielding. A typical specific electric conductivity of the end corona shield amounts, for example, to about 1.5*10⁵ Ω/squared to 1.6*10⁶ Ω/squared). Glass of this type is suitable for the manufacture of endless fibers of typical thickness of 2-50 μm, using typical devices. Of course, other thicknesses are possible as well. The electric conductivity can be attained, for example, through addition of polyvalent components, such as iron oxides. Iron oxides are present in glass in the form of Fe²⁺ and Fe³⁺ and realize an intrinsic conductivity by an electron “hopping” mechanism. The electric conductivity fluctuates preferably by less than the factor 2.

Glasses are made from raw material under addition of iron compounds such as Fe₂O₃, FECO₃ or Fe₃O₄ so as to be meltable. Care should be taken to create reproducible conditions for manufacture. A defined ratio between Fe²⁺ and Fe³⁺ can hereby be adjusted. The conductivity is particularly dependent on this ratio. Glass which includes electrically conductive inorganic material may thus contain, e.g., iron oxide, a copper oxide, or other transition metal oxides. When glass contains iron oxide, the iron is present in glass in the form of Fe²⁺ or Fe³⁺.

Glass with intrinsic electron conductivity can also be used for outer corona shielding (OCS). A typical specific conductivity of 0.03-0.5 Ω/squared is hereby of special importance for glass. Endless fibers of typical thickness of 10-20 μm can be made by typical devices from this type of glass for outer corona shielding, like for end corona shielding. Compared to materials for end corona shielding, the material for outer corona shielding has a conductivity which is higher by about 5 orders of magnitude. In other words, the concentration of the polyvalent components should be increased significantly. The conductivity may, however, also be obtained through partial crystallization.

The same considerations essentially apply for glasses for outer corona shielding as for the glasses for end corona shielding. Thus, the glass systems should be carefully selected and the ratio of oxidized species/reduced species should be carefully adjusted.

The same applies for quality measurement of oxygen in the melt as in glasses for end corona shielding. In the event of glasses for outer corona shielding, the tolerance by which the redox conditions are adjusted is significantly lower. The oxygen activity should be adjusted to a value in correspondence to maximal conductivity for cooled glasses.

As a result of a use of thermally stable inorganic materials, the corona shield accordance to the invention is temperature-resistant up to a temperature of up to 500° C. Thus, the electric machine can be subjected to higher loads as far as end corona shielding and outer corona shielding are concerned, so that the electric machine can run efficiently for higher thermal tasks as well as higher electric tasks. The conductivity of the fabric or non-woven remains unaffected by a VPI-impregnation process. Contamination of the VPI impregnation fluid through electrically conductive components of the corona shield (fillers) is of no concern because of the absence of any electrically conductive fillers in an organic carrier material.

Corona shielding is of particular relevance in electric machines in addition to its function as insulation. This is true especially for high-voltage machines at a voltage from about 3.3 kV. Three parameters are relevant for developing insulation system for machines:
thermal stability,
thermal heat conductivity, and
electric properties.

Electric properties involve electric resistance as well as distribution of electric field strengths. In particular, when high-voltage machines are involved, mica based insulation systems are used. Mica allows realization of maximum field strength of about 3.5 kV/mm. The insulation of conductors in electric machines can be so constructed that the conductor is enclosed by an insulating layer which in turn is wrapped by a corona shield as additional layer. The corona shield assists in the implementation of an even field distribution on the surface of the conductor. Moreover, the corona shield demarcates within the electric machine the stator slots of the laminated stator core. The laminated stator core is for example set to zero potential or to neutral potential. The outer corona shielding has different electric properties than the end corona shielding. The insulation as well as the corona shield of an electric machine is dependent on the use of the electric machine. In particular, when operating an electric machine on power converters which execute a pulse modulation, the insulation and the corona shield has to satisfy higher requirements.

According to another feature of the present invention, the electrically conductive inorganic material may be silicon carbide. The fibers or threads or rovings produced therefrom are preferably made of glass which contains for example SiC (especially for end corona shielding) or transition metal oxides. Conductive electric inorganic materials (transition metal oxides) are not adversely impacted by partial discharges so that the shortcomings of conductive organic materials are eliminated.

According to another feature of the present invention, the electrically conductive inorganic material in the filaments of the corona shield may be electrically conductive ceramics. Of course, the electrically conductive inorganic material may be realized by any combination of silicon carbide, electrically conductive ceramics and transition oxides or other inorganic materials set forth herein.

According to another feature of the present invention, the corona shield may be made entirely of inorganic material, or by a combination of electrically conductive filaments and electrically non-conductive filaments. In this way, the concentration of the material responsible for effecting the electric conductivity can be changed and the electric conductivity of the corona shield can be adjusted in a much simple and more cost-efficient manner as compared to an adjustment by doping.

A corona shield can thus be configured with different electric properties. An end corona shield may hereby have a resistance value of 5×10⁸ Ω/squared, whereas an outer corona shield may have a typical resistance value of 1000 Ω)/squared. In general the resistance value will depend however on many factors which may involve voltage or length of an end corona shield. The corona shield, regardless whether for outer corona shielding or end corona shielding, can be provided for potential equalization on the surface of the primary insulation. The corona shield further provides a homogenization of the electric field. An end corona shield provides a lowering of the potential of the laminated stator core of the electric machine. Field strengths encountered in air upon the conductor with attached corona shield are now prevented from causing arcing, and the generation of partial discharges, glow discharges or sliding discharges on the surface of the primary insulation are now prevented by a corona shielding in accordance with the present invention.

As described above, a corona shield according to the present invention is especially applicable for electric high-voltage machines, which are typically operated at a voltage above 3 kV, in order to effect a potential equalization on the conductors.

According to another aspect of the present invention, a method of making a corona shield includes the steps of adding electrically conducting inorganic material to a glass melt to produce a glass melt product, and producing filaments from the glass melt product to make a fabric or non-woven fabric, e.g. in the form of a band for use as corona shield.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a fragmentary perspective illustration of a laminated stator core equipped with a corona shield according to the present invention for insulating a conductor;

FIG. 2 is a fragmentary sectional view showing in detail an exit area of the conductor from the laminated stator core;

FIG. 3 is a graphical illustration showing the relation between conductivity as a function of the concentration of electrically conductive substances;

FIG. 4 is a schematic illustration of one variation of a fabric for a corona shield according to the present invention; and

FIG. 4a is a schematic illustration of another variation of a fabric for a corona shield according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have different inventive entity. Both applications are unique, but incorporate the other by reference. Accordingly, the following U.S. patent application is hereby expressly incorporated by reference: “Corona Shield, and Method of Making a Corona Shield”.

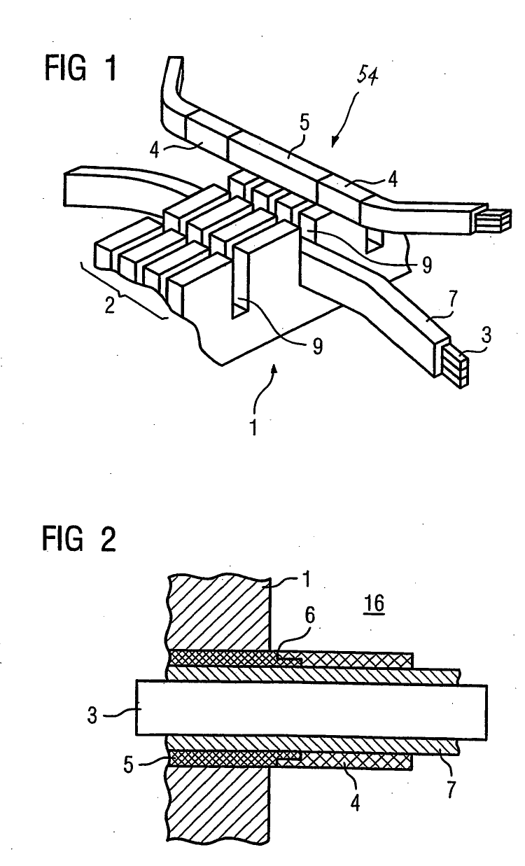

Turning now to the drawing, and in particular to FIG. 1, there is shown a fragmentary perspective illustration of a laminated stator core, generally designated by reference numeral 1. The stator core 1 is made up of laminations 2 and includes stator slots 9 for receiving copper conductors 3. The copper conductors 3 are wrapped by an insulation 7 which is constructed stronger inside the stator core 1 than on the outside of the stator core 1, where the copper conductors 3 form a winding overhang (not shown in FIG. 1). Attached to the insulation 7 of the copper conductor 3 is a corona shield, according to the present invention, generally designated by reference numeral 54 for insulating the copper conductor 3. The corona shield 54 includes an outer corona shield 5 for wrapping the area of the copper conductor 3 within the stator core 1, and an end corona shield 4 for wrapping the area of the copper conductor 3 outside the stator core 1. The outer corona shield 5 as well as the end corona shield 4 control the electric potential.

The corona shield 54 is made of a substrate (carrier layer) formed from filaments which are coated by a further layer to provide electric conductivity through inclusion of electrically conductive inorganic material. Although not shown in detail, it is, of course, conceivable to provide the corona shield 54 with more than one substrate and/or more than one further layer. The substrate may be realized by a fabric having threads which contain the electrically conductive inorganic material or by a non-woven fabric having fibers which contain the electrically conductive inorganic material.

FIG. 2 shows in more detail a transition zone of the copper conductor 3 from the stator core 1 to an area of air 16 to illustrate the insulation 7 and the corona shield 54 with both outer corona shield 5 and end corona shield 4 which are placed in overlapping relationship in a jointing area 6. The stepped connection between the outer corona shield 5 and the end corona shield 4 is realized by winding the corona shield 54 as band onto the insulation 7 of the copper conductor 3 half overlappingly so that the corona shield 54 is wrapped about the insulation 7 in two layers for example. Of course, other winding processes known to the artisan are possible as well in order to effect a single-layer or multi-layer wrapping by a band.

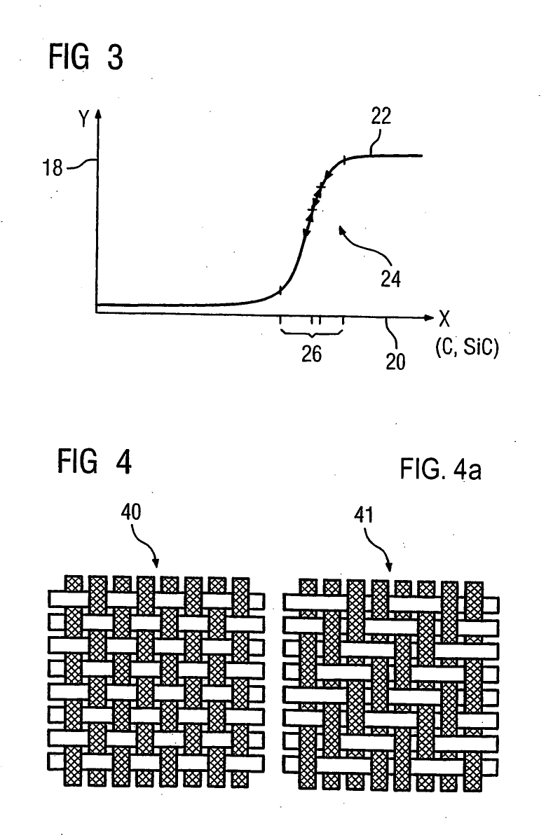

Turning now to FIG. 3, there is shown a graph 22 illustrating the relation between conductivity on the y-axis 18 as a function of the concentration of electrically conductive substances on the x-axis 20. Examples of an electrically conductive material include carbon or silicon carbide. The graph 22 illustrates a steep ascent 24 within a narrow range 26 in which the concentration changes. This illustrates the problems faced by the prior art to adjust the concentration of conductive materials through impregnation of a carrier material. Dripping or condensation easily results in a shift of the concentration and ultimately to a substantial change in the conductivity. As a result of using inorganic material for constructing the substrate and the further layer of the corona shield 54 and the provision of an electric conductivity through provision of the electrically conductive material within the further layer, the afore-stated problem is overcome.

FIG. 4 shows a fabric 40 made through linen weave, and FIG. 4a shows a fabric 41 made through twill weave. Both weave types are to be understood as examples only for a fabric to form a substrate for a further layer, or for a fabric having coated filaments.

The filaments are made of glass which is doped with electrically conductive material. These glass fibers are used to make a fabric, e.g. through linen weave with wefts and warps. Stability and flexibility can be adjusted in dependence on the selected weave type. In general, the fabric should be made as thin as possible. The fabric structure is also relevant to influence a smoothing of the field.

Examples of conductive inorganic materials include metals of different oxidation stages. As the outer corona shield 5 has a higher electric conductivity compared to the end corona shield 4, a higher concentration of metals of different oxidation stages within the corona shield allows a change of an end corona shield to an outer corona shield.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A corona shield for an electric machine, comprising a substrate made of filaments which contain electrically conductive inorganic material.

2. The corona shield of claim 1, wherein the substrate is a fabric made of threads as filaments, wherein the threads contain the electrically conductive inorganic material.

3. The corona shield of claim 1, wherein the substrate is a non-woven fabric made of fibers as filaments, wherein the fibers contain the electrically conductive inorganic material.

4. The corona shield of claim 1, wherein the substrate is a combination of a fabric made of threads which contain the electrically conductive inorganic material, and a non-woven fabric made of fibers which contain the electrically conductive inorganic material.

5. The corona shield of claim 1, wherein the filaments are made of glass.

6. The corona shield of claim 1, wherein the electrically conductive inorganic material is at least a transition metal oxide.

7. The corona shield of claim 6, wherein the transition metal oxide includes a metal selected from the group consisting of iron, vanadium, manganese, chromium, cobalt, nickel, copper, arsenic, or antimony.

8. The corona shield of claim 1, wherein the electrically conductive inorganic material is an iron oxide.

9. The corona shield of claim 8, wherein the iron oxide is selected from the group consisting of FeO and Fe₂O₃.

10. The corona shield of claim 1, wherein the electrically conductive inorganic material is a copper oxide.

11. The corona shield of claim 1, wherein the electrically conductive inorganic material is silicon carbide.

12. The corona shield of claim 1, wherein the electrically conductive inorganic material is electrically conductive ceramics.

13. The corona shield of claim 1, wherein the electrically conductive inorganic material is included in the substrate at a range of about 5% to 35%.

14. The corona shield of claim 1, wherein the filaments contain a combination of at least two different electrically conductive inorganic materials.

15. The corona shield of claim 1, wherein the substrate is made entirely of inorganic material.

16. The corona shield of claim 1, wherein the substrate is made of a combination of electrically conductive material and electrically non-conductive material.

17. The corona shield of claim 1 for use as outer corona shield.

18. The corona shield of claim 1 for use as end corona shield.

19. The corona shield of claim 1 for use in an electric high-voltage machine.

20. A method of making a corona shield, comprising the steps of:
adding electrically conducting inorganic material to a glass melt to produce a glass melt product; and
producing filaments from the glass melt product to make a fabric for use as corona shield.

21. An electric machine, comprising a corona shield having a substrate made of filaments which contain electrically conductive inorganic material.
